(19) United States
(12) Patent Application Publication
(10) Pub. No.: US 2012/0312895 A1
(43) Pub. Date: Dec. 13, 2012

(54) Fluid Dispensing Device for Discharging Fluid Simultaneously in Multiple Directions

(75) Inventors: Matthew N. Thurin, Wauwatosa, WI (US); Darren K. Robling, Racine, WI (US); Linda Moy Madore, Vernon Hills, IL (US); Ronald H. Spang, Kenosha, WI (US); Charles P. Althoff, Brooklyn, NY (US); Hideaki Matsui, New York, NY (US); Brook S. Kennedy, Glen Ridge, NJ (US); Stian Tesdal, New York, NY (US)

(73) Assignee: S.C. JOHNSON & SON, INC., Racine, WI (US)

(21) Appl. No.: 13/157,095

(22) Filed: Jun. 9, 2011

(51) Int. Cl. B05B 3/10; B05B 1/14; B05B 1/32; E03D 9/02; B05B 3/04

(52) U.S. Cl. 239/222.15; 4/223; 239/579; 239/575; 239/590.5

(57) ABSTRACT

A fluid dispensing device is provided that is capable of discharging fluid in multiple different directions simultaneously. The device may include a deflector which redirects an initial stream of fluid from the container into multiple sub-streams that are oriented in different directions. The device may create a spray pattern that substantially covers an entire 360 degree area surrounding the device, which may be advantageous for certain applications such as toilet bowl cleaner dispensers. A control valve or flow restrictor may be provided for preventing unintended discharge of fluid when the container is inverted.

### FIELD OF THE DISCLOSURE

The present disclosure generally relates to fluid dispensing devices and, more particularly, to fluid dispensing devices capable of delivering fluid in multiple directions simultaneously.

### BACKGROUND OF THE DISCLOSURE

Various types of fluid dispensing devices are known for dispensing controlled amounts of fluid in a spray pattern. In general, previous devices discharge product in a single direction, typically to avoid spraying product onto the user. Other conventional fluid dispensing devices may provide multiple discharge outlets, however only one outlet may be used at any given time, and therefore these devices still discharge in a single direction.

In certain applications, such as toilet bowl cleaners, the product is applied to the toilet bowl in a full, 360° arc. Conventional toilet bowl cleaner dispensers, which discharge product in a single direction, require rotation of the user's hand and arm to cover the entire area of the bowl with product. Additionally, the angle at which the product discharges from the dispenser often requires the user to further contort his or her body to point the dispenser in the desired direction.

### SUMMARY OF THE DISCLOSURE

According to certain aspects of this disclosure, a dispensing closure is provided for attachment to a container, in which the dispensing closure includes a closure body adapted for coupling to the container and defining a dispensing surface and a dispensing orifice formed in the closure body and defining an orifice axis along which an initial fluid flow path extends from the dispensing orifice. A deflector is coupled to the closure body and supported in spaced relation to the dispensing surface to define a dispensing gap between the closure body and the deflector, the deflector including a deflector surface oriented to face the dispensing orifice. The deflector surface is configured to generate a spray pattern extending at a deflection angle with respect to the orifice axis, the spray pattern extending in at least two directions simultaneously.

According to additional aspects of this disclosure, a fluid dispensing device may include a container having a connection end defining an opening, a cap assembly defining a cap axis and a discharge orifice oriented at a deflection angle relative to the cap axis, the cap assembly including, and a cap having a side wall rotatably coupled to the container and defining an internal chamber fluidly communicating with the container opening, wherein rotation of the cap relative to the container actuates the cap between an open position and a closed position. A deflector is coupled to the side wall of the cap and includes a deflector surface defining a discharge path extending between the container opening and the discharge orifice. The cap assembly is configured to permit fluid flow through the discharge path when the cap is in the open position and prevent fluid flow through the discharge path when the cap is in the closed position

### BRIEF DESCRIPTION OF THE DRAWINGS

For a more complete understanding of this disclosure, reference should be made to the embodiments illustrated in greater detail on the accompanying drawings, wherein:

FIG. 1 is a perspective view of an exemplary fluid dispensing device constructed according to the teachings of the present disclosure.

FIG. 2 is a perspective view of a second exemplary embodiment of a fluid dispensing device constructed according to the teachings of the present disclosure.

FIG. 3 is a perspective view of a third exemplary embodiment of a fluid dispensing device constructed according to the teachings of the present disclosure.

FIG. 4 is perspective view of a fourth exemplary embodiment of a fluid dispensing device constructed according to the teachings of the present disclosure.

FIG. 5 is a side elevation view of the fluid dispensing device of FIG. 4.

FIG. 6 is a top view of the fluid dispensing device of FIG. 4.

FIG. 7 is an enlarged side elevation view, in cross section, of a top portion of the fluid dispensing device of FIG. 4.

FIG. 8 is an exploded view of the top portion of the fluid dispensing device of FIG. 4.

FIG. 9 is an enlarged perspective view of an exemplary control valve used in the fluid dispensing device of FIG. 4.

FIG. 10 is a side elevation view, in cross-section, of another embodiment of a fluid dispensing device.

FIG. 11 is a side elevation view, in cross-section, of a further embodiment of a fluid dispensing device.

FIG. 12 is a side elevation view, in cross-section, of yet another embodiment of a fluid dispensing device.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE DISCLOSURE

Various embodiments of fluid dispensing devices are disclosed for use with a container holding a product, wherein the dispensers generate a spray pattern that simultaneously extends in multiple directions. The product may be a viscous or non-viscous fluid. The container may be a flexible squeeze container, an aerosol container, or other known structure for holding a flowable product. The action needed to dispense the product may be manual or automatic. The dispenser may be positioned at any usable location on the container, such as the top, bottom, or side of the container. Additionally, the dispenser may be operative in any usable orientation of the container, such as vertically upright, inverted, horizontal, or tipped/angled orientation. In general, the dispensers accomplish a multi-direction spray pattern by directing one or more streams of fluid in multiple directions simultaneously.

As used herein, the term “spray jet” refers to the three-dimensional shape of the material between the exit orifice and the target surface, while the term “spray pattern” refers to the two-dimensional area of the target surface that is covered by material when the nozzle is held stationary.

Fluid dispensing devices may use a variety of different containers. The containers may hold one or a combination of various ingredients, and typically use a permanent or temporary pressure force to discharge the contents of the container. When the container is an aerosol can, for example, one or more chemicals or other active ingredients to be dispensed are usually mixed in a solvent and are typically further mixed with a propellant to pressurize the can. Known propellants include carbon dioxide, selected hydrocarbon gas, or mixtures of hydrocarbon gases such as a propane/butane mix. For convenience, materials to be dispensed may be referred to herein merely as “actives”, regardless of their chemical nature or intended function. The active/propellant mixture may be stored under constant, but not necessarily continuous, pressure in an aerosol can. The sprayed active may exit in an emulsion state, single phase, multiple phase, and/or partial gas phase. Without limitation, actives can include insect control agents (such as propellant, insecticide, or growth regulator), fragrances, sanitizers, cleaners, waxes or other surface treatments, and/or deodorizers.

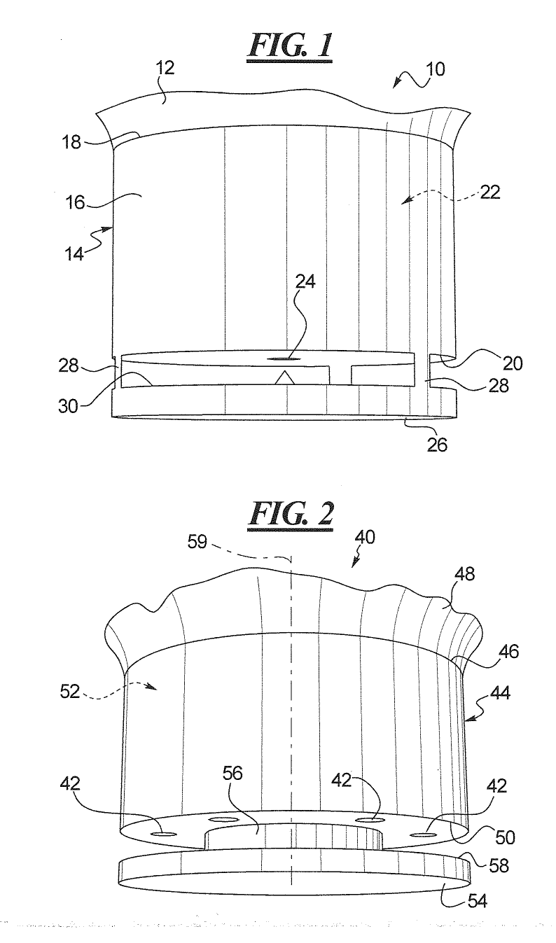

An exemplary embodiment of a fluid dispensing device 10 is illustrated in FIG. 1 as including a container 12 and a closure 14. The closure 14 includes a base 16 having a first end 18 adapted for attachment to the container 12 and a second end 20. The base 16 defines an internal chamber 22 and an orifice 24 is formed in the base second end 20 and fluidly communicates with the internal chamber 22. A deflector piece 26 is supported in axially spaced relation to the base 16, such as by arms 28. The deflector piece 26 defines a deflector surface 30 facing the orifice 24 and configured to separate an initial product stream exiting the orifice into multiple final product streams projecting in different radial directions. The deflector surface 30 may include a diverter 32 aligned with the orifice 24 to assist with separating the initial product stream into the final product streams. During operation, product discharged from the orifice 24 contacts the deflector surface 30, which directs the product toward multiple different directions simultaneously.

An alternative embodiment of a fluid dispensing device 40 is illustrated in FIG. 2. This embodiment is similar to that of FIG. 1, but uses multiple orifices 42 to create the initial product flow. More specifically, a base 44 includes a first end 46 configured for attachment to a container 48, and further includes a second end 50. The base 44 defines an internal chamber 52 and the multiple, separate orifices 42 are formed in the base second end 50 and fluidly communicate with the internal chamber 52. A deflector piece 54 is supported in axially-spaced relation to the base 44, such as by a central hub 56. The deflector piece 54 includes a deflector surface 58 that faces the orifices 42 formed in the base 44. The deflector surface 58 is configured to produce radial fluid flow paths oriented at different radial angles relative to a longitudinal axis 59 of the base 44. During operation, product is discharged simultaneously through the multiple orifices 42 to form multiple initial product streams. The initial product streams contact the deflector surface 58 and are redirected in a radial direction, thereby generating simultaneous final product streams in multiple radial directions.

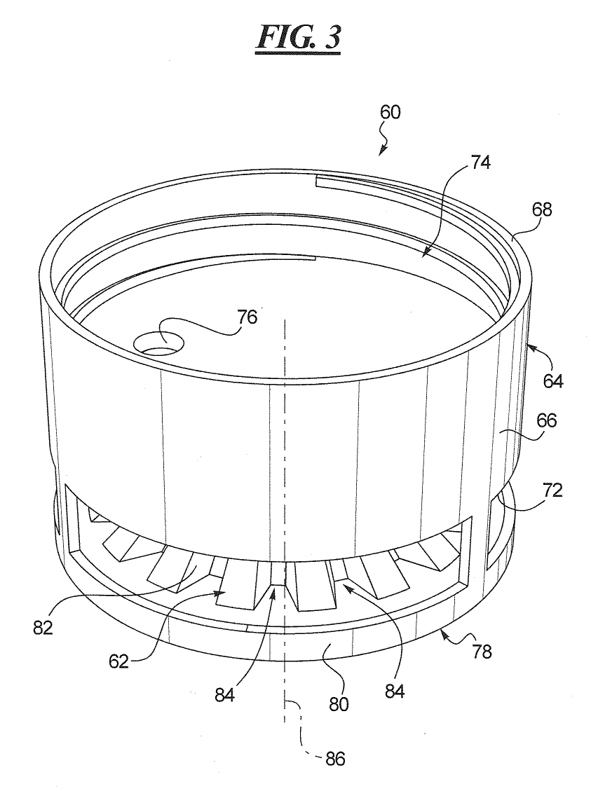

A third embodiment of a fluid dispensing device 60 is illustrated in FIG. 3 that incorporates a rotatable deflector plate 62. This embodiment includes a closure 64 having a base 66 with a first end 68 configured for attachment to a container (not shown) and a second end 72. The base 66 defines an internal chamber 74, and an orifice 76 is formed in the base second end 72 and fluidly communicates with the internal chamber 74. A deflector assembly 78 is supported in axially spaced relation to the base second end 72 and includes a support 80 and the deflector plate 62. The deflector plate 62 is rotatably mounted on the support 80 and includes a deflector surface 82 generally facing the orifice 76. The deflector surface 82 may include multiple channels or grooves 84 for forming final product streams. The orifice 76 may be offset from an axis of rotation 86 of the deflector plate 62. In operation, an initial product stream discharged from the orifice 76 contacts the deflector plate 62, thereby causing the deflector plate 62 to rotate. Product contacting the deflector plate 62 is then projected radially off of the spinning deflector plate 62 due to the force of product flow as well as the centrifugal force generated by the deflector plate rotation. Thus, multiple final product streams are generated simultaneously and projected toward multiple different radial directions.

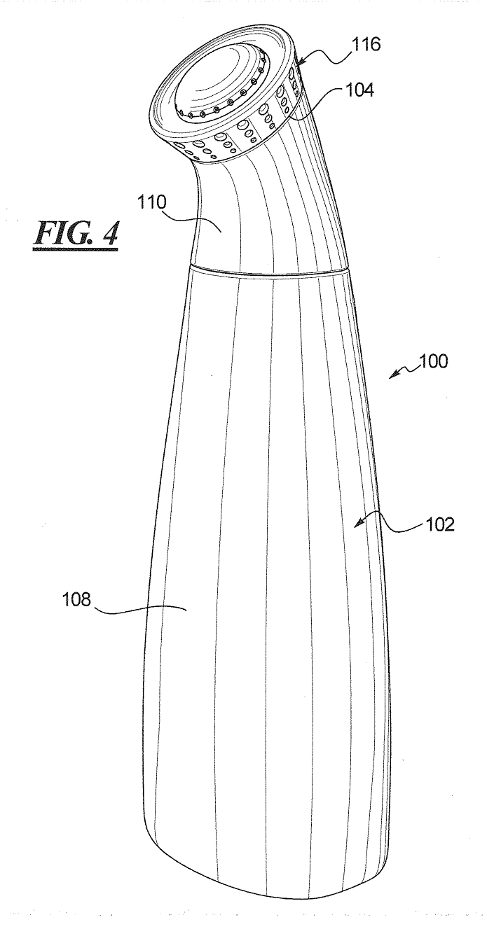

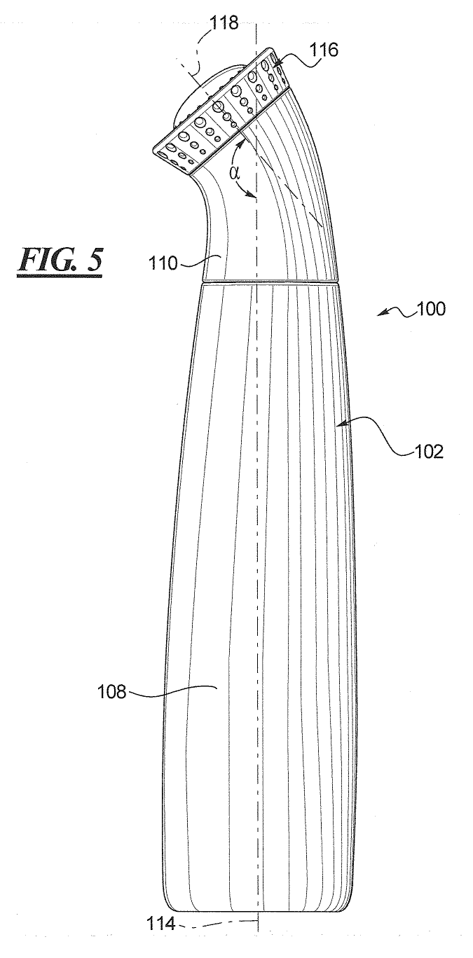

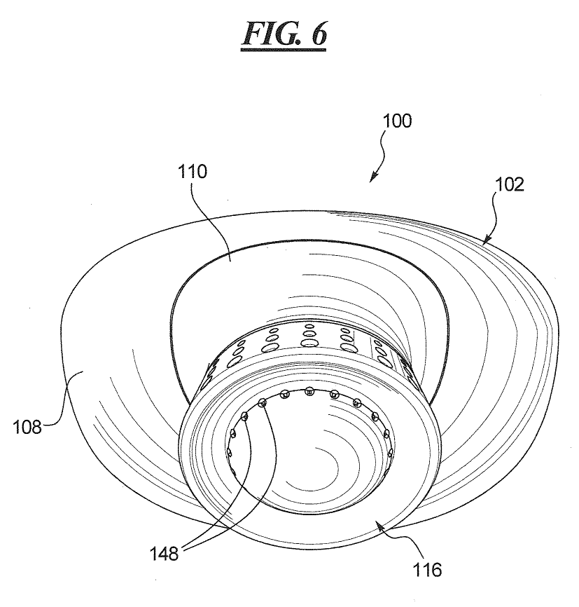

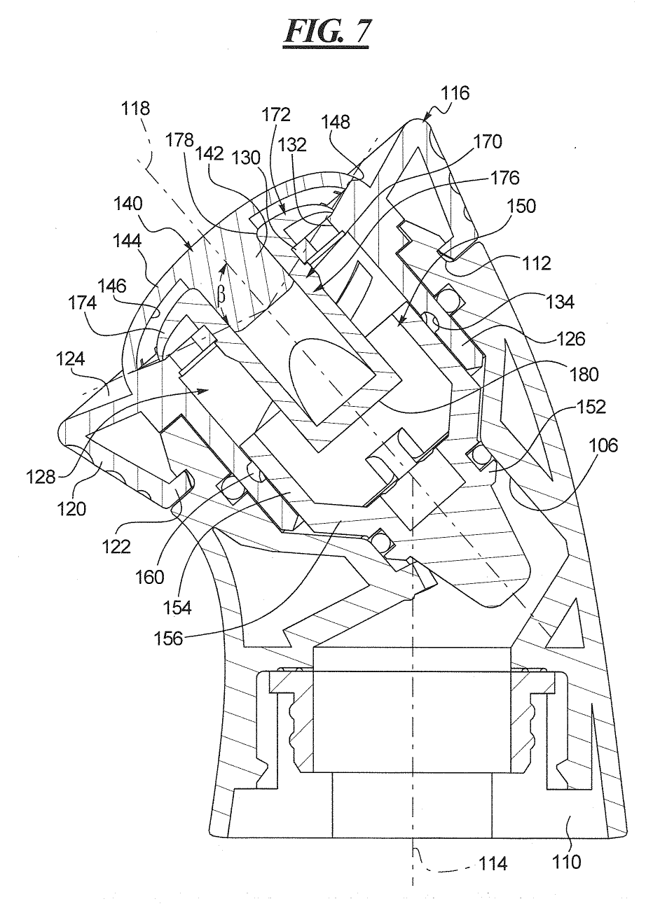

Yet another embodiment of a fluid dispensing device 100 is illustrated in FIGS. 4-9. The fluid dispensing device 100 includes a container 102 having a connection end 104 defining an opening 106 (FIG. 7). While the container 102 is described herein as being formed from a manually deformable material, such as plastic, so that the fluid may be discharged under manual pressure, it will be appreciated that other types of containers and dispensing mechanisms may be used, such as plastic or metal aerosol cans, and rigid containers using manually or automatically operated pumps. In the exemplary embodiment, the container 102 includes a lower housing 108 coupled to an upper housing 110. Alternatively, the container 102 may have a unitary construction, in which the lower housing 108 and upper housing 110 are formed integrally as a single component. The container 102 further includes an annular recess 112 formed at the connection end 104. The container 102 generally extends along a container axis 114.

A cap 116 is coupled to the container 102 for directing fluid exiting the container opening 106. As best shown in FIG. 7, the cap 116 is generally oriented along a cap axis 118. 18. The cap axis 118 may be oriented at a cap angle relative to the container axis 114 that is advantageous for an intended use. For example, the fluid dispensing device 100 may be used to dispense toilet bowl cleaner, in which case the device 100 would be inverted during use. During such use, the user will typically hold the container 102 in front of the user's body with both hands. From an ergonomic standpoint, it is difficult to hold the container 102 in a substantially vertical orientation without excessive bending of the arms and/or wrists, and therefore it is more natural for the container 102 to be held at an acute angle relative to the vertical direction. Accordingly, to more easily place the cap 116 in a vertical orientation, the cap axis 118 extends at a cap angle α relative to the container axis 114. In some embodiments the cap angle α is approximately 45 to 55 degrees, and in the illustrated embodiment the cap angle α is approximately 50 degrees.

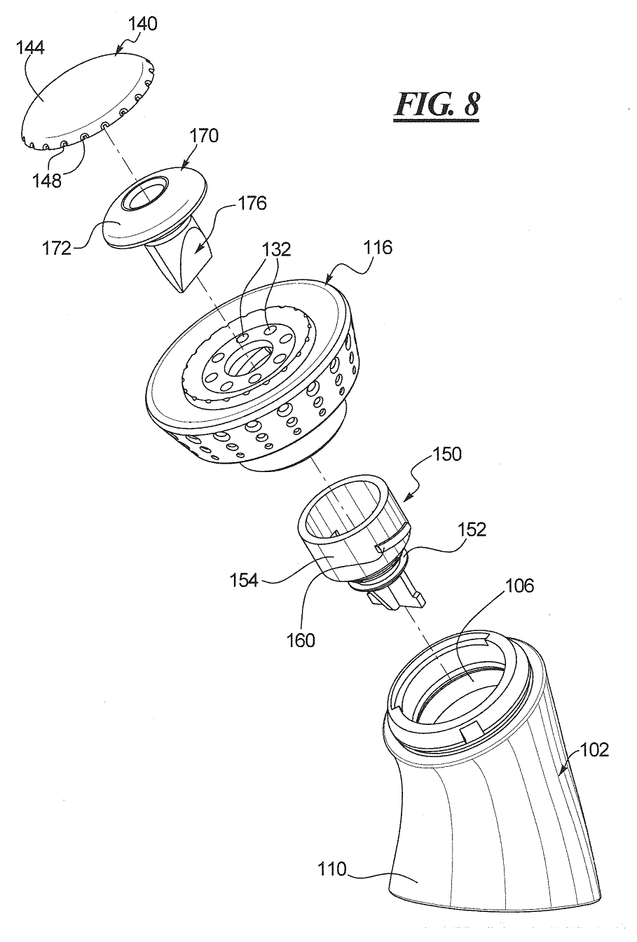

The cap 116 includes an outer sidewall 120. A lower flange 122 extends radially inwardly from a bottom end of the outer sidewall 120 and is rotatably received by the annular recess 112 of the container 102, thereby permitting the cap 116 to rotate about the cap axis 118 relative to the container 102. A top wall 124 extends radially inwardly from a top end of the outer sidewall 120. An inner sidewall 126 is attached to the top wall 124 and extends axially inwardly into the container 102 to define an internal chamber 128 that fluidly communicates with the container opening 106. An upper flange 130 extends radially inwardly from a top end of the inner sidewall 126 and defines a plurality of dispensing orifices 132 (FIG. 8) fluidly communicating with the internal chamber 128 and oriented substantially parallel to the cap axis 118. The cap 116 may further include a cam slot 134 formed in an interior surface of the inner sidewall 126.

A deflector 140 is coupled to the cap 116 for directing the fluid generally in a radially outward direction. As best shown in FIGS. 7 and 8, the deflector 140 includes a central stem 142 coupled to the cap 116 and a cover 144 extending outwardly from the stem 142. In the illustrated embodiment, the cover 144 has a semi-spherical shape, however other configurations that direct fluid generally direct fluid in radial directions away from the cap axis 118 may be used. The cover 144 defines a deflector surface 146 that is spaced from but extends over the dispensing orifices 132.

A plurality of discharge openings 148 are formed in an outer edge of the cover 144 to create spray jets of fluid extending radially outwardly from the cap 116. In the exemplary embodiment, the cover 144 has approximately twenty discharge openings 148, however more or less openings may be used. The discharge openings 148 may be evenly spaced around a perimeter of the cover 144 so that they are oriented at discrete radial angles, thereby to form simultaneous multiple spray jets directed in multiple different directions during use. Alternatively, the discharge openings 148 may be configured to create a spray pattern formed as a continuous curtain of fluid. As a further alternative, the discharge openings 148 may be unevenly spaced around the cover 144 so that some discharge openings 148 are more closely spaced while other discharge openings 148 are spaced farther apart from each other. Such an uneven distribution of discharge openings 148 may be advantageous for covering a surface that is not uniformly spaced from the device 10, such as an oval-shaped toilet bowl. The spray jets may form an overall spray pattern that covers a desired coverage angle around the cap 116. For example, the coverage angle may be 360° to provide a spray pattern that extends continuously around the cap 116, as may be advantageous for applications.

Alternatively, the coverage angle may be less than 360°, depending on the particular application. For example, the discharge openings 149 may be formed only partially around the cover 144 to form a spray pattern that extends around a coverage angle of 180°, 160°, 90° or any other coverage angle less than 360°. While the discharge openings 148 may be entirely formed in the cover 144, the illustrated embodiment shows discharge openings 148 that are formed between complimentary voids in both the cover 144 and the cap 116.

Each of the discharge openings 148 may be oriented to form a spray jet that projects at a deflection angle relative to the cap axis 118. In the exemplary embodiment, each discharge opening 148 is oriented at a deflection angle β of approximately 70 degrees, however other deflection angles may be used without departing from the scope of this disclosure. For example, a deflection angle β of approximately 90 degrees may be used, or even a deflection angle β of greater than 90 degrees may be used for spraying difficult to reach areas, such as under the rim of a toilet bowl. Additionally, the discharge openings 148 of the cover 144 may be oriented at multiple different deflection angles. For example, some of the discharge openings 148 may be oriented at a first deflection angle (such as approximately 70 degrees) while other discharge openings 148 of the same cover 144 may be oriented at a second deflection angle (such as approximately 75 degrees). Still other discharge openings 148 may be oriented at a third or more deflection angles. While the illustrated discharge openings 148 are shown having substantially the same diameters, the discharge openings 148 may alternatively have different diameters. Still further, while the discharge openings 148 are shown oriented along substantially radial paths extending from the cap axis 118, one or more of the discharge openings 148 may be oriented at an angle relative to the radial path.

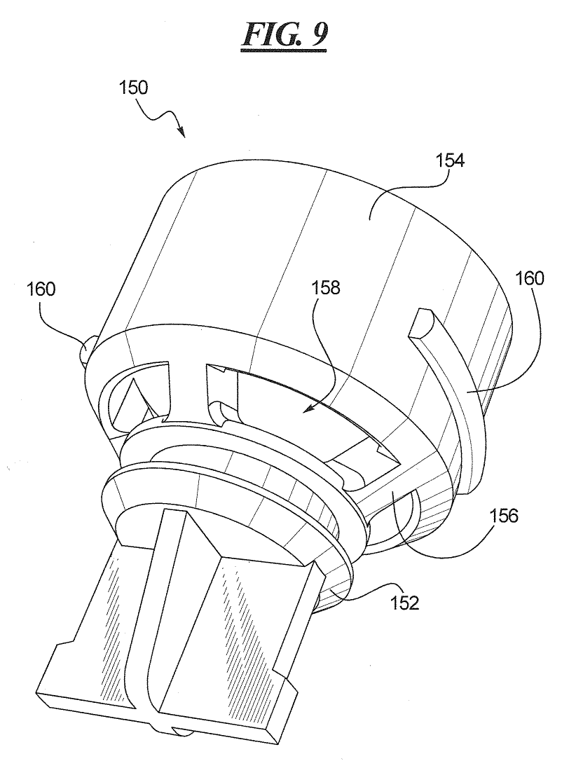

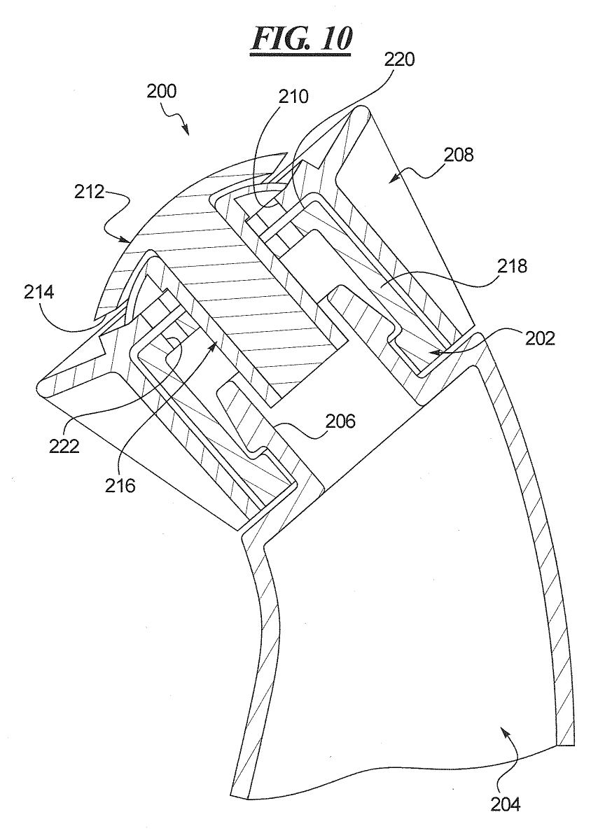

A control valve 150 may be provided to permit fluid flow only when desired. The exemplary control valve 150 includes a valve body 152 sized to sealingly engage the container opening 106. The valve body 152 is coupled to an outer wall 154 by a plurality of webs 156 (FIG. 9). Spaces 158 between the webs permit fluid flow into an interior of the outer wall 154. The outer wall 154 may telescope within the cap inner sidewall 126 so that the interior of the outer wall 154 fluidly communicates with the internal chamber 128.

The outer wall 154 may be operatively coupled to the cap 116 to move the valve body 152 between open and closed positions. In the exemplary embodiment, two cam tabs 160 extend from an exterior surface of the outer wall 154 and are sized for slidable insertion into the cam slot 134. Accordingly, rotation of the cap 116 slides the cam tabs 160 along the slot 134, thereby translating the control valve 150 along the cap axis 118. Rotating the cap 116 in a first direction drives the control valve 150 to the closed position, in which the valve body 152 sealingly engages the container opening 106. Rotating the cap 116 in a second, opposite direction drives the control valve 150 to the open position, in which the valve body 152 is spaced from the container opening 106. In the open position, fluid may flow through the container opening 106 and the spaces 158 in the control valve 154 into the internal chamber 128.

A combination valve 170 may provide a dispensing orifice valve for controlling flow of fluid through the dispensing orifices 132, and a vent valve for controlling vent air flow into the container 102. An outer portion of the combination valve 170 provides a discharge valve 172 for controlling fluid flow through the dispensing orifices 132. The discharge valve 172 comprises an annular flap 174 formed of a material that deflects in response to pressure differential between the internal chamber 128 and atmosphere. Specifically, the flap 174 is configured to have a normally closed position, in which the flap 174 extends over the dispensing orifices 132 to prevent fluid flow therethrough, as best shown in FIG. 7. Should the pressure inside the internal chamber 128 be elevated, such as by a user squeezing the container 102, the fluid pressure overcomes the initial bias force of the flap 174 and moves the flap 174 to an open position spaced from the dispensing orifices 132, thereby permitting fluid flow therethrough. When the fluid pressure inside the internal chamber 128 is subsequently reduced, the flap 174 returns to the normally closed position to again prevent fluid flow through the dispensing orifices 132.

An inner portion of the combination valve 170 may be formed as a one-way vent valve 176 to control the flow of vent air into the container 102. The one-way vent valve 176 includes a vent valve inlet 178 fluidly communicating with atmosphere and a vent valve outlet 180 fluidly communicating with the cap internal chamber 128. The one-way vent valve 176, which may be formed as a duckbill valve, is configured to permit fluid flow from the vent valve inlet 178 to the vent valve outlet 180. Accordingly, the one-way vent valve 176 is configured to be normally closed during operation, but will open when the pressure inside the internal chamber 128 is below the atmospheric pressure, thereby to permit vent air to enter the container 102. For example, where a user squeezes the container 102 to discharge fluid, the subsequent release of the container will reduce the pressure inside the internal chamber 128, thereby permitting air to be drawn into the container 102 through the one-way vent valve 176.

Another embodiment of a fluid dispensing device 200 is illustrated in FIG. 10. The fluid dispensing device 200 is similar to the device 100 except for using a different control valve 202. Accordingly, the device 200 includes a container 204 defining an opening 206, and a cap 208 coupled to the container 204 and defining a plurality of dispensing orifices 210 in fluid communication with the container opening 206. A deflector 212 is coupled to the cap 208, and an outer edge of the deflector 212 defines a plurality of discharge openings 214 configured to create spray jets of fluid extending radially outwardly from the cap 208. A combination valve 216 may also be provided for performing the fluid flow control and venting functions noted in the preceding embodiment.

The fluid dispensing device 200 further includes the control valve 202 for selectively opening or closing the device. As best shown in FIG. 10, the control valve 202 includes a side wall 218 coupled to the container 204 and a top wall 220. A plurality of valve orifices 222 are formed in the top wall 220, with each valve orifice 222 being aligned with a respective dispensing orifice 210. The cap 208 and control valve 202 are rotatable relative to each other to move between an open position shown in FIG. 10, in which the valve orifices 222 communicate with the dispensing orifices 210, and a closed position, in which the valve orifices 222 do not communicate with the dispensing orifices 210.

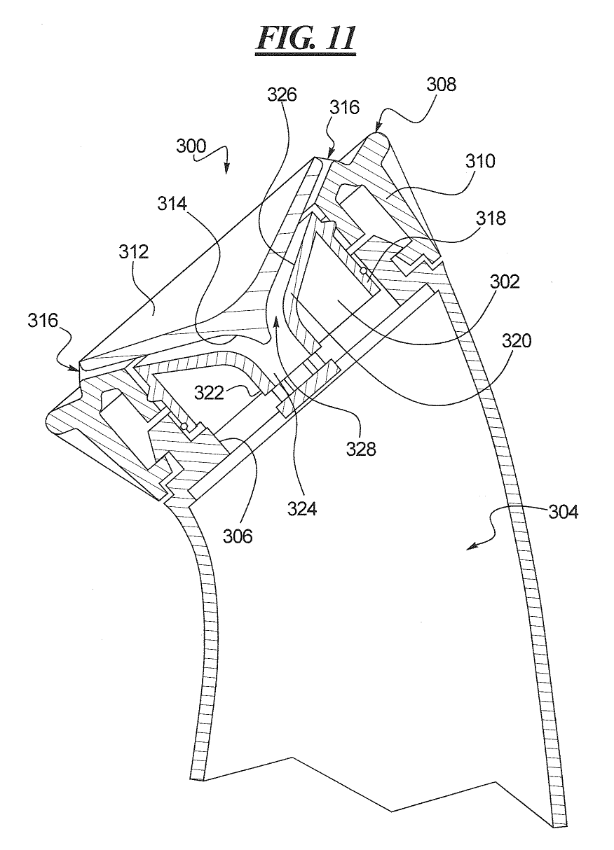

A further embodiment of a fluid dispensing device 300 is illustrated in FIG. 11. This device 300 includes a control valve 302, but instead of using an orifice valve to prevent inadvertent flow as the container is inverted in the open position, the components are configured to create a capillary passage that uses the surface tension of the fluid to retain the fluid until discharge is desired. The fluid dispensing device 300 includes a container 304 defining an opening 306. A cap 308 is rotatably coupled to the container 304 and includes a side wall 310 for gripping by the user and a deflector 312. The deflector 312 defines a deflector surface 314 having a generally frusto-conical shape. Discharge orifices 316 are formed between the side wall 310 and the deflector 312.

The control valve 302 is operably coupled to the cap 308 to move axially in response to rotation of the cap 308. The control valve 302 includes an outer wall 318 rotatably coupled to the cap 308 and a transition wall 320 having a frusto-conical shape that extends radially inwardly from the outer wall 318. A generally cylindrical inner wall 322 is coupled to the transition wall 320 and defines a valve inlet 324. The transition wall 320 defines a valve seat 326 that is shaped to sealingly engage the deflector surface 314 when the control valve 302 is in the closed position. When the control valve is actuated to the open position, as shown in FIG. 11, the valve seat 326 is spaced a relatively small distance from the deflector surface 314 to define a flow restrictor in the form of a capillary passage 328. The capillary passage 328 is relatively long and narrow, so that the surface tension of the fluid will resist fluid flow. When product flow is desired, the user may squeeze the container 304 to increase pressure inside the container 304 sufficiently to overcome the fluid surface tension, thereby permitting fluid to flow through the capillary passage 328 and exit from the discharge orifices 316.

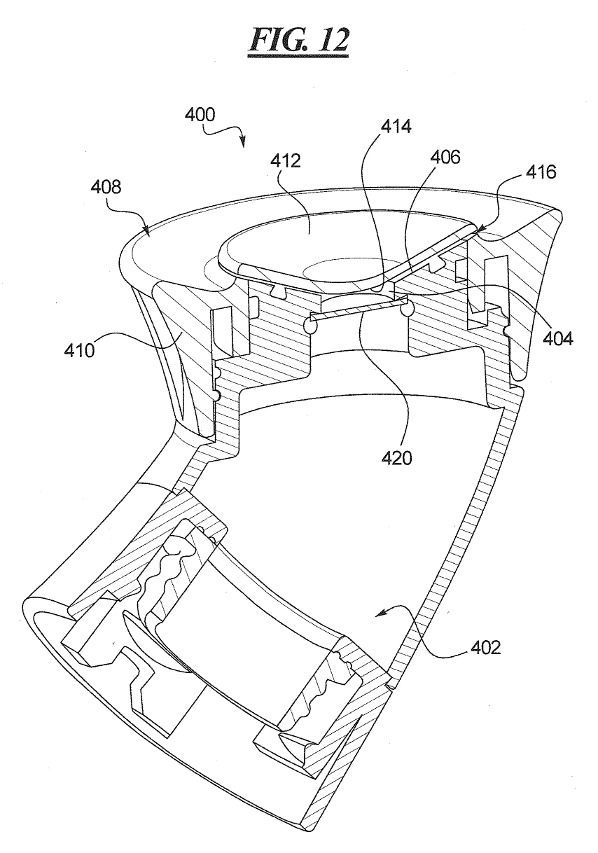

Yet another embodiment of a fluid dispensing device 400 is illustrated in FIG. 12. This device 400 is similar to the device 300 of FIG. 13, however a flow restrictor is used to further prevent unintended discharge of product instead of a capillary passage. More specifically, the fluid dispensing device 400 includes a container 402 defining an opening 404 surrounded by a valve seat 406. In the exemplary embodiment, the valve seat 406 has a frusto-conical shape. A cap 408 includes a side wall 410 rotatably coupled to the container 402. The cap 408 also includes a deflector 412 defining a deflector surface 414, with discharge orifices 416 being formed between the side wall 410 and the deflector 412. The deflector surface 414 also has a generally frusto-conical shape and is configured to sealingly engage the valve seat 406 when the cap 408 is in the closed position. When the cap 408 is in the open position, the deflector 412 moves away from the container 402 so that the deflector surface 414 is spaced from the valve seat 406, thereby permitting fluid communication from the container opening 404 to the discharge orifices 416. A flow restrictor, such as a screen 420, is coupled to the container 402 and positioned upstream of the opening 404, thereby to slow or restrict the flow of fluid during normal conditions.

While such embodiments have been set forth, alternatives and modifications will be apparent in the above description to those skilled in the art. These and other alternatives are considered equivalents in the spirit and scope of this disclosure and the appended claims.

### INDUSTRIAL APPLICABILITY

The various embodiments of a fluid dispensing device disclosed herein may be capable of discharging fluid in multiple directions simultaneously. The device may be used to dispense fragrances, cleaners, pest repellants, or other types of actives.

What is claimed is:

1. A dispensing closure for attachment to a container, the dispensing closure comprising:
a closure body adapted for coupling to the container and defining a dispensing surface;
a dispensing orifice formed in the closure body and defining an orifice axis along which an initial fluid flow path extends from the dispensing orifice; and
a deflector coupled to the closure body and supported in spaced relation to the dispensing surface to define a dispensing gap between the closure body and the deflector, the deflector including a deflector surface oriented to face the dispensing orifice, the deflector surface configured to generate a spray pattern extending at a deflection angle with respect to the orifice axis, the spray pattern extending in at least two directions simultaneously.

2. The dispensing closure of claim 1, in which the deflector surface includes an impact hub aligned with the orifice axis.

3. The dispensing closure of claim 1, further comprising a second dispensing orifice formed in the closure body and defining a second orifice axis for a second initial fluid flow path, and in which the deflector surface is further oriented to face the second dispensing orifice.

4. The dispensing closure of claim 1, in which the deflection angle is approximately 90°.

5. The dispensing closure of claim 1, in which the deflector surface is formed on a deflector disc that is rotatably coupled to the deflector.

6. The dispensing closure of claim 5, in which the deflector surface includes multiple radial grooves extending from a center of the deflector disc to a periphery of the deflector disc.

7. The dispensing closure of claim 6, in which the radial grooves are configured to generate a rotational force sufficient to rotate the deflector disc when contacted by liquid.

8. A fluid dispensing device, comprising:
a container having a connection end defining an opening; and
a cap assembly defining a cap axis and a discharge orifice oriented at a deflection angle relative to the cap axis, the cap assembly including:
a cap having a side wall rotatably coupled to the container and defining an internal chamber fluidly communicating with the container opening, wherein rotation of the cap relative to the container actuates the cap between an open position and a closed position; and
a deflector coupled to the side wall of the cap and including a deflector surface defining a discharge path extending between the container opening and the discharge orifice;
wherein the cap assembly is configured to permit fluid flow through the discharge path when the cap is in the open position and prevent fluid flow through the discharge path when the cap is in the closed position.

9. The fluid dispensing device of claim 8, in which the cap further includes a dispensing orifice spaced from and aligned with the deflector surface to create an initial fluid flow path, and in which the deflector has an outer edge defining a plurality of discharge openings, each discharge opening positioned at a discrete radial angle and configured to generate a spray jet of fluid, wherein a spray pattern generated by the fluid dispensing device is formed by the spray jets.

10. The fluid dispensing device of claim 9, in which the cap assembly further comprises a control valve supported for rotation relative to the cap and including a valve opening, wherein the valve opening is aligned with the dispensing orifice when the cap is in the open position, and wherein the valve opening is blocked from the dispensing orifice when the cap is in the closed position.

11. The fluid dispensing device of claim 8, in which the cap assembly further comprises a control valve operably coupled to the cap and including a valve body, wherein the valve body sealingly engages the container opening when the cap is in the closed position, and wherein the valve body is spaced from the container opening when the cap is in the open position.

12. The fluid dispensing device of claim 11, in which the cap is rotatably coupled to the container and includes a cam slot, and the control valve further comprises a cam tab slidably received in the cam slot.

13. The fluid dispensing device of claim 9, in which the cap assembly further comprises a discharge valve associated with the dispensing orifice and movable between a closed position, in which the discharge valve overlies the dispensing orifice, and an open position, in which the discharge valve is spaced from the dispensing orifice.

14. The fluid dispensing device of claim 8, further comprising a valve seat disposed around the container opening, in which the deflector surface is configured to sealingly engage the valve seat to close off the container opening when the cap is in the closed position, and in which the deflector surface is closely spaced from the valve seat when the cap is in the open position, thereby to form a capillary passage.

15. The fluid dispensing device of claim 14, in which the valve seat is formed on a control valve operably coupled to the cap.

16. The fluid dispensing device of claim 14, in which the valve seat is formed on the container.

17. The fluid dispensing device of claim 8, further comprising a flow restrictor positioned upstream of the discharge path.

18. The fluid dispensing device of claim 17, in which the flow restrictor comprises a screen.

19. The fluid dispensing device of claim 8, in which the cap assembly further comprises a one-way vent valve having a vent valve inlet fluidly communicating to atmosphere and a vent valve outlet fluidly communicating with the internal chamber of the cap, wherein the one-way vent valve is configured to permit fluid flow from the vent valve inlet to the vent valve outlet and to prevent fluid flow from the vent valve outlet to the vent valve inlet.

20. The fluid dispensing device of claim 8, in which the cap comprises a plurality of dispensing orifices substantially equally spaced from the cap axis.

21. The fluid dispensing device of claim 8, in the deflection angle of each discharge orifice is approximately 70 degrees.

22. The fluid dispensing device of claim 8, in which the container defines a container axis, and in which the cap axis is oriented at a cap angle of approximately 45 to 55 degrees relative to the container axis.

23. The fluid dispensing device of claim 8, in which the container is formed of a material that is deformable under manual pressure.
